(19) United States
(12) Patent Application Publication
(10) Pub. No.: US 2008/0226431 A1
(43) Pub. Date: Sep. 18, 2008

(54) Rotating Machines for Treating Containers

(75) Inventors: Nicolas Chomel, Octeville sur Mer (FR); Jean-Michel Rius, Octeville sur Mer (FR); Frederic Lecomte, Octeville sur Mer (FR); Guy Feuilloley, Octeville sur Mer (FR)

Correspondence Address: YOUNG & THOMPSON, 209 Madison Street, Suite 500, ALEXANDRIA, VA, 22314, US

(73) Assignee: Sidel Participations, Octeville Sur Mer (FR)

(21) Appl. No.: 12/091,819

(22) PCT Filed: Oct. 18, 2006
(86) PCT No.: PCT/EP2006/067537

§ 371 Date: Apr. 28, 2008

(30) Foreign Application Priority Data
Oct. 28, 2005 (FR) 0553289

(51) Int. Cl. B65H 1/00; B23Q 7/02

(52) U.S. Cl. 414/222.01

(57) ABSTRACT

The invention concerns a rotating machines for treating containers. When a workstation Pi enters (&thetas;1) a treatment zone, the treating equipment automatically consists of a stationed part (Eq 1) and a common part (Cj) which is mutually coupled with another workstation which is not located at the same time as the station (Pi) in the working zone (3). The same arrangement is used for a control equipment.

The present invention relates to improvements to rotating machines for treating containers, especially machines for depositing a barrier layer on the walls of containers.

In the prior art, container treatment machines have already been proposed in which a plasma, produced by a microwave generator from a specific gas, is used to deposit a barrier layer on the inside wall of the container. The barrier layer improves the barrier properties of the treated container by preventing the migration of gas from the inside out and/or from the outside in. This extends the storage life of the product contained in the treated container.

To treat a container requires the use of a variety of mechanical, hydraulic, pneumatic or electrical components, and in particular the use of a vacuum chamber or cavity in which the container is placed, in addition to the use of a plasma generator which may consist for example of a magnetron or other high-frequency source, and that of a high-voltage electrical source to supply the generator, said source being connected to an electricity supply assembly under the control of a control cabinet.

In addition, pumping-out circuits and precursor gas feed circuits are used to inject into the container, positioned in the chamber, after the vacuum has been created in the chamber and in the container, a gas or gas mixture which, when turned into a plasma by the high frequencies, is deposited onto the wall (usually the inside wall) of the container.

Besides the actual production of barrier layers, the treatment may require the use of devices for measuring or monitoring the quality of the plasma or the quality of other parameters in order to take corrective action in real time or after analysis of the results.

In this description, the term “treatment” will be applied without distinction to operations connected with the production of the barrier layer itself or with measurement or monitoring operations.

In the prior art, barrier layer depositing machines have already been described, in which a central turntable carries a number of workstations, each carrying out an identical sequence of treatment operations on at least one container in the course of one revolution of the turntable. The stations are distributed usually at regular intervals around the periphery of the turntable, and the treatment from one station to the next, and consequently the elementary operations corresponding from one station to the next, are separated by a time lag.

Each workstation comprises in particular a vacuum chamber or cavity as mentioned above, in addition to the corresponding plasma generator, and its high-voltage electricity supply source for powering the generator under the control of a control cabinet; each station may also have devices for measuring or monitoring the quality of the plasma or measuring or monitoring other parameters. The stations are also connected to pumping-out circuits and to circuits for injecting a precursor. The machine also possesses means for loading and unloading the containers into and out of the treatment chambers.

The treatment performed at one workstation occupies a portion of a revolution of the turntable. Each operation of the sequence itself occupies a portion of a revolution of the turntable of greater or lesser amplitude: in other words, each operation requires the station in question to travel around an angular sector of greater or lesser amplitude, the duration of each operation being a function of the value of the angular sector in question and the angular velocity of the turntable. The treatment commences with the loading (introduction) of the containers onto the turntable, followed by the operations necessary to produce the barrier layer, and ending with the unloading (exit) of the treated containers. Monitoring or measuring operations may also take place at particular times as the turntable revolves.

Known machines have a number of drawbacks, namely due to the cost of their components, such that the cost price of such machines is directly affected by the number of workstations the machine has, especially the electrical and electronic components which are of high precision and therefore expensive, because each workstation has each of the abovementioned components.

The problem is aggravated when it is wished to increase the throughput of such machines, because the first action is naturally to increase the number of stations present on the turntable. The problem with this is that, while it may be attractive to accelerate the unit rate of each station by accelerating the speed of rotation of the turntable, in practice this is found to be difficult or ineffective because of the mechanical stresses that can arise from such acceleration and because of the fact that the minimum duration of the treatment proper (not counting container loading/un-loading operations and pumping-out operations) cannot be reduced, for a given quality of barrier layer, below a certain minimum value.

Besides the cost problems, which particularly relate to the total cost of the electrical or electronic components required for the treatment, measurement or monitoring, to increase the number of workstations in this way adds to the problems of mechanical construction, owing especially to the increase in the on-board mass.

In order to solve the aforementioned problems of the prior art, the present invention makes use of the fact that the rotational structure of the machine results in identical sequences of operations with a time lag from one station to the next, and that in addition at least one of the operations of the sequence performed at one station is performed with a full time lag relative to the same operation performed at another station. What is meant by “with a full time lag” is that the operation in question commences and ends on one station before the same operation commences and ends on another station. In the remainder of the description and in the claims the expression “full lag” will be used in place of “full time lag”.

In a first example of an embodiment, the invention relates to a rotating machine for treating products, the rotating machine comprising a central turntable carrying at least two identical workstations, each performing during one revolution of the turntable an identical predetermined sequence of treatment operations with a time lag from one station to the other, at least one of the operations of said sequence being carried out with a full lag from one station to the other, and which is characterized in that each station comprises at least one station-specific part with first means designed to be used when said operation with a full lag is being carried out, and in that the machine comprises at least one common part with second means designed to be used when said operation with a full lag is being carried out, and in that the machine comprises combiner means for linking said common part or parts as required to the station-specific part of a workstation for the duration necessary to carry out said operation with a full lag on this station, and enable said operation to be carried out by among other things the combined action of the first means of the station-specific part of this station and of the second means of the common part connected thereto, and in that combiner means are provided to allow a station-specific part to be connected to one of the common parts available when the corresponding workstation enters the treatment zone.

In a second example of an embodiment, the invention relates to a rotating machine for treating products, comprising a central turntable carrying a plurality of identical workstations, each performing during one revolution of the turntable an identical predetermined sequence of treatment operations with a time lag from one station to the other, at least one of the operations of said sequence being carried out with a full lag from one station to the other, and which is characterized in that each station comprises at least one station-specific part with first means designed to be used when said operation with a full lag is being carried out, and in that the machine comprises at least one common part with second means designed to be used when said operation with a full lag is being carried out, and in that the machine comprises combiner means for linking said common part or parts as required to the station-specific part of a workstation for the duration necessary to carry out said operation with a full lag on this station, and enable said operation to be carried out by among other things the combined action of the first means of the station-specific part of this station and of the second means of the common part connected thereto, and in that at least one combiner means is permanently connected to the station-specific parts of at least two workstations.

The machine is thus simplified and optimized, by sharing the resources between multiple stations as soon as any given operation can be carried out with a full lag between two stations, as is in fact possible in theory whatever the number of stations on the machine provided the operation is carried out in an angle of less than 180°. The means included in the common part or parts may be expensive and/or voluminous electronic or electrical components.

Depending on the number of stations on the machine and the angular sector required by an operation that can be performed with full lag, it is conceivable to have a greater or lesser degree of sharing:
thus, if a given operation within the sequence occupies an angular sector smaller than or equal to that separating two successive stations of the turntable, a single common part with means dedicated to said operation will be necessary to enable all the stations to perform said operation one by one; in this case the combiner means will make the common part available in succession to the station-specific part of each workstation;
if on the other hand a given operation within the sequence occupies an angular sector greater than that separating two successive stations on the turntable, so that two or more stations may be simultaneously performing the same operation of the sequence, yet without being at the same stage in said operation, and if it is not possible to share resources between two stations, two or more common parts will be required, with means making it possible to contribute to the performance of said operation, which common parts will be made available as required to different station-specific parts.

In accordance with other features of the invention,
the combiner means comprise a multiplexing means for activating the electrical connection between the common part and a station-specific part when said operation with a full lag is to be carried out in the station comprising said station-specific part;
the combiner means comprise an electrical connection assembly connecting a common part to at least two station-specific parts and a multiplexing means for activating the active electrical connection between the common part and a station-specific part when said operation with a full lag is to be carried out in the station comprising said station-specific part;
the multiplexing means for activating the electrical connection comprises an electronic multiplexing circuit that produces an activation signal when a station enters that portion of the revolution of the machine during which the operation is to be carried out;
the multiplexing means for activating the electrical connection comprises an electric multi-plexing circuit consisting of at least one activation contactor controlled by the detection of the entrance into or exit from a portion of a revolution of the rotating machine corresponding to the carrying out of said operation;
the contactor is a commutator rotating about a central shaft of the rotating machine and sliding contacts making contact with the commutator;
the contactor is set back from the station which it activates;
the set-back contactor comprises a moving part designed to come into contact with a cam located so as to relate to that portion of the revolution of the rotating machine which corresponds to the carrying out of said operation;
the common part has a microwave supply generator for a magnetron for treating products in a treatment operation using a plasma and the station-specific part comprises at least one magnetron;
the microwave supply generator comprises a circuit for generating a high-voltage supply, designed to be shared between multiple station-specific parts;
the microwave supply generator also comprises at least two microwave control circuits designed to be shared between multiple station-specific parts;
the common part comprises means for measuring and analyzing a signal representing a treatment parameter and the station-specific part comprises a sensor of said signal; the measurement and analysis means consist of an analyzer of the signal measuring the light intensity of the plasma generated by a magnetron and the signal sensor is a sensor of the energy radiated by the plasma generated by a magnetron provided for the station.

Other advantages and features of the present invention will be understood more clearly from examining the description and appended figures, in which:

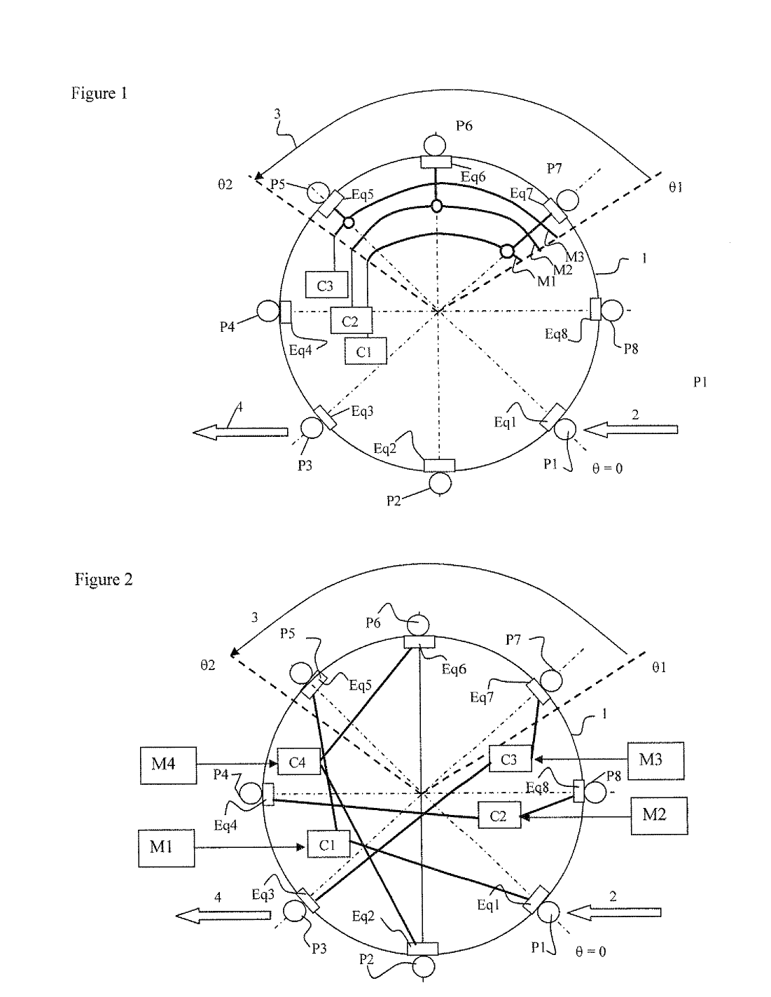

FIG. 1 is a schematic view of an instantaneous position of the turntable of a rotary container treatment machine on which a first example of the invention is being carried out, during one operation in the sequence;

FIG. 2 is a schematic view of an instantaneous position of the turntable of a rotary treatment machine on which a second example of the invention is being carried out, during one operation in the sequence;

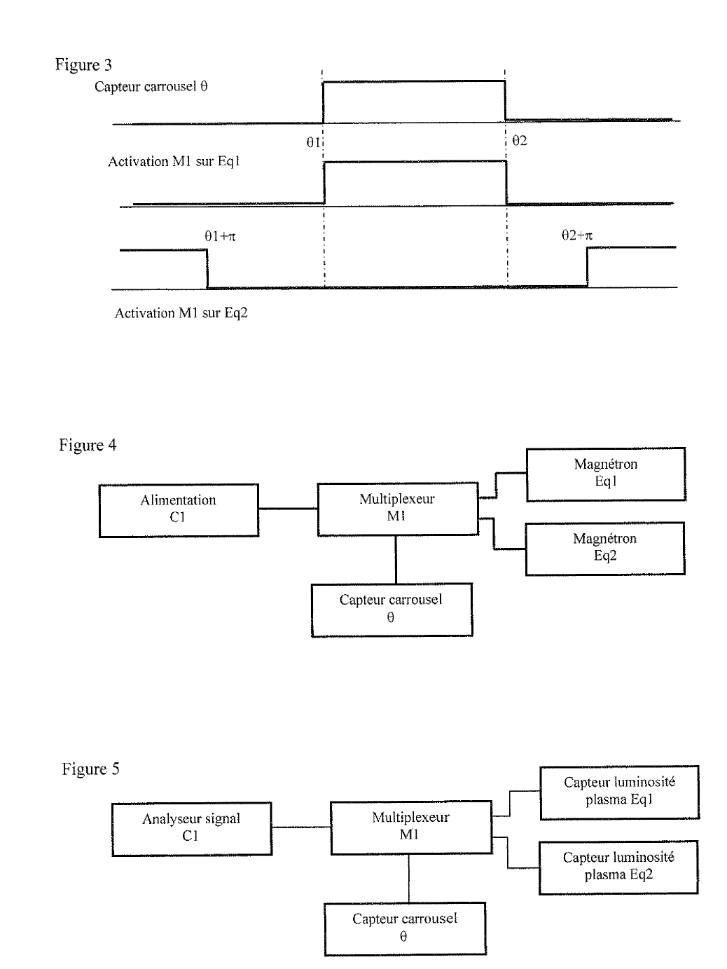

FIG. 3 is a diagram of signals for controlling the treatments carried out in the machines shown in FIGS. 1 and 2;

FIG. 4 shows an application to one particular embodiment;

FIG. 5 shows an application to another embodiment;

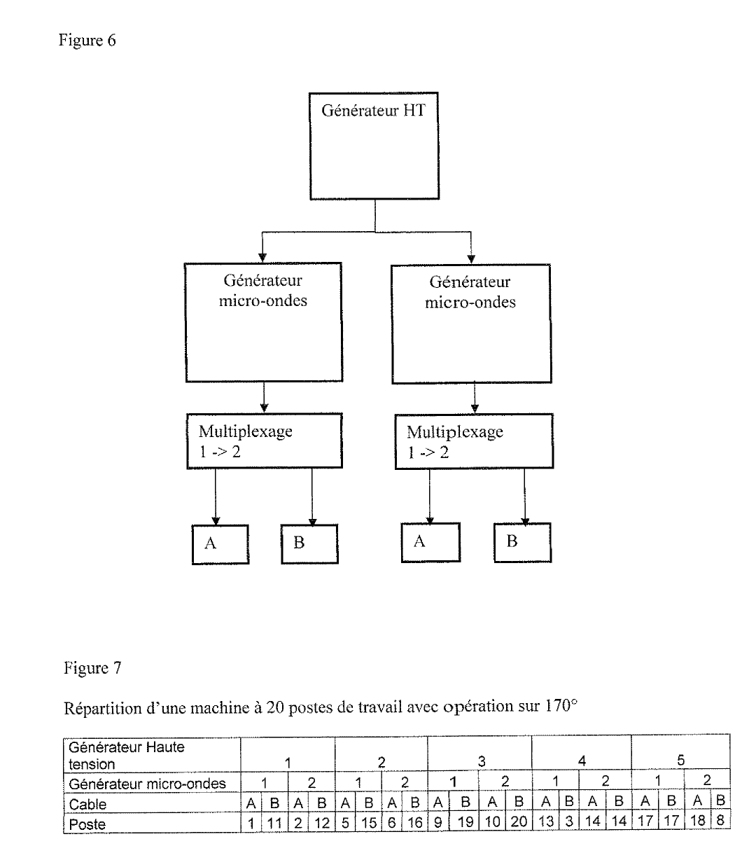

FIG. 6 shows a particular application to a microwave generator suitable for the above-mentioned treatment machine;

FIG. 7 shows a sequence of treatment operations carried out with the aid of the application shown in FIG. 6;

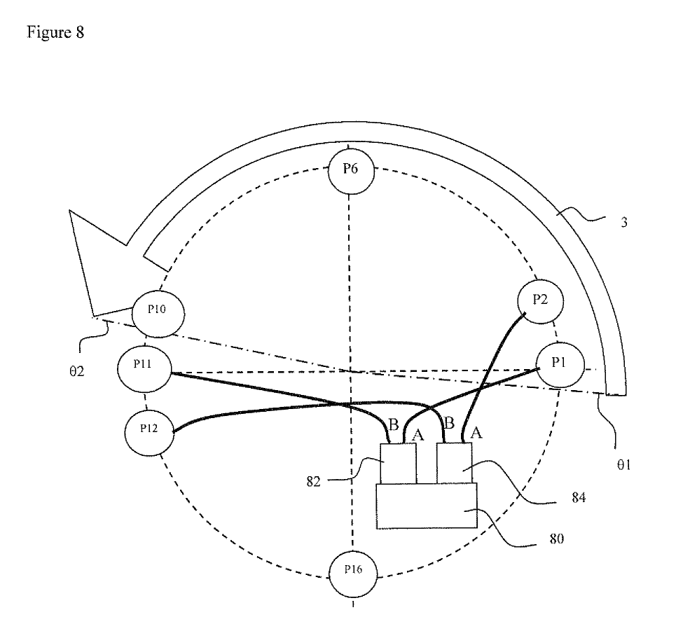

FIG. 8 shows the arrangement of such an application as seen in FIG. 6 to a rotating machine according to the invention;

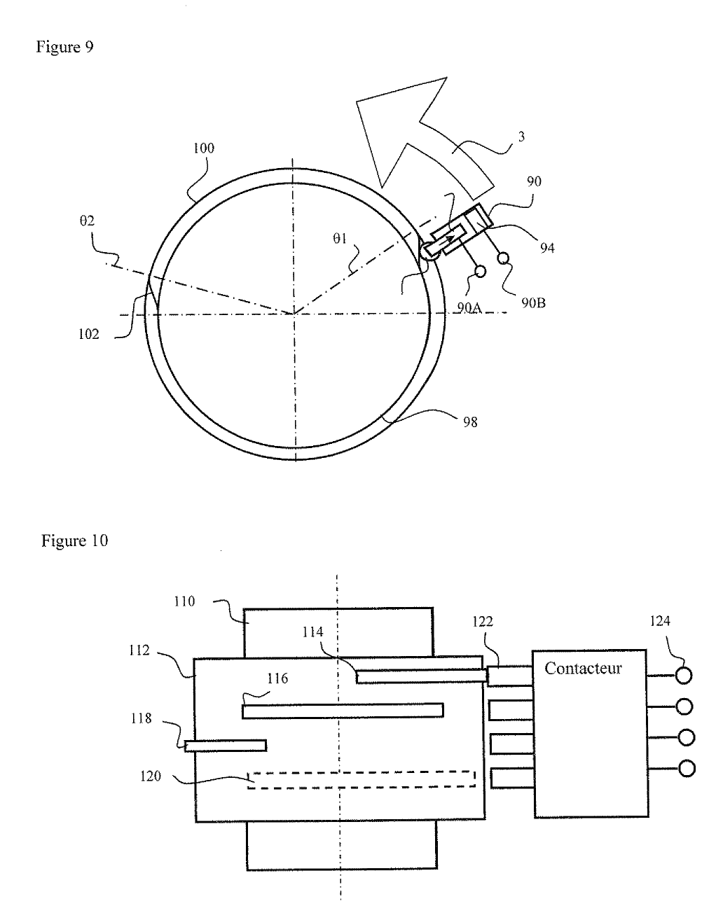

FIG. 9 shows one particular arrangement for detecting the elements associated with the angular progress around a rotating machine as shown in FIG. 1, 2 or 8;

FIG. 10 shows one particular embodiment of a system for transferring control signals to a rotating machine as shown in FIG. 1, 2 or 6; and

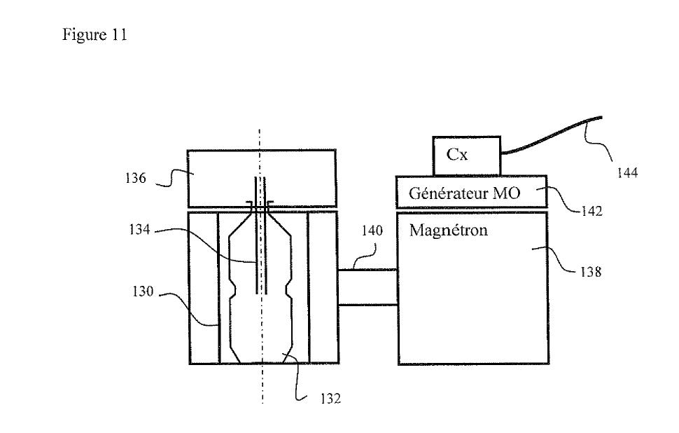

FIG. 11 shows an arrangement applied to a workstation in a rotary container treatment machine as shown in FIG. 8.

FIG. 1 is a schematic view of part of a rotary container treatment machine designed particularly for depositing a barrier layer by means of a microwave plasma treatment as described above.

This description will describe more specifically the way in which the invention can be applied to the operations of the sequence consisting in the application of the microwaves or in the measuring of parameters during the treatment, more especially parameters associated with plasma formation, that a person skilled in the art will be able to extrapolate the application of the invention to other resource-sharing operations of the sequence.

The machine shown in FIG. 1 comprises a main part consisting of a turntable 1 that rotates about a central shaft.

The turntable carries a plurality of identical workstations distributed regularly about its circumference.

In the first example illustrated in FIG. 1, the turntable 1 carries eight workstations P1 to P8. Workstation P1 is shown in an angular position θ=0 corresponding to the position of introduction of the containers into the station.

In this position, in a manner known per se, an untreated container can be loaded (as shown by arrow 2) in synchronization with the rotation 3 of the turntable into workstation P1.

The operation is repeated every time a new station presents itself, in other words one-eighth of a revolution in the example of the machine illustrated here.

The loading operation involves inserting the container to be treated into a vacuum chamber. Following this operation, the chamber is closed and the interior of the container and of the chamber is pumped out. An injector is also lowered into the container to be treated, either before or during or after pumping out. Next, a gas mixture is injected by the injector into the container contained in workstation P1.

In the first example, when a workstation reaches position θ1, it enters an angular region of the turntable in which the operation of the sequence involving applying microwave energy to create the plasma inside the container is carried out. The plasma is created by using a gas mixture which has already been injected, and correctly applying microwave energy.

The microwave treatment is applied until the workstation arrives at an angular position θ2 as will be described below. Then, on leaving position θ2, the turntable 1 continues rotating, the container treated in a workstation is brought back to atmospheric pressure, and finally the workstation arrives at a position illustrated by arrow 4, where the container treated by the microwave treatment applied between positions θ1 and θ2 is unloaded.

Thus far we have only described the successive operations applied to a container inserted in a single workstation.

The eight workstations rotating with the turntable 1 are of course carrying out exactly the same operations at the same frequency with a time lag corresponding to the time required for each workstation to cover one-eighth of the circumference.

It is known practice to make machines with a much greater number of workstations, typically up to 20 or 40 workstations. This is to allow an optimal rate of microwave treatment.

FIG. 1 shows the first example, in which at any instant only three workstations can be simultaneously inside the angular sector comprised between θ1 and θ2.

This means that at any given moment five of the eight microwave treatment units are not being used, or that a unit is being used for only three-eighths of a revolution of the turntable.

According to the invention, each treatment unit comprises:
first station-specific parts Eq1-Eq8 connected directly, electrically and mechanically to each station P1 to P8;
a number of common parts, in this case three parts C1 to C3, which can be shared by several stations.

In practice, in the example illustrated, the number of common parts is equal to the number of workstations that may be simultaneously within the angular sector comprised between θ1 and θ2.

Thus, depending on availability, the station-specific part Eq1 of station P1 will be connected to one of the common parts C1 to C3 of that treatment unit which is available at the moment it enters angular position θ1 within the treatment zone.

In the first example of the invention, shown in FIG. 1, a cluster of combiner means M1, M2, M3 allows a station-specific part Eq1 to Eq8 to be connected to one of the common parts C1, C2 or C3 available as the corresponding unit enters position θ1 of the treatment zone.

In one particular embodiment, which will be described later, the cluster of means M1, M2, M3 forms a multiplexed connector or addressing device designed so that the station-specific part Eq1 to Eq8 of the station P1 to P8 arriving at position θ1 is connected to a common treatment unit part C1 to C3 available at this moment the station P1 to P8 in question arrives at position θ1.

In one embodiment, the rotary treatment machine of the invention comprises a sequence sensor, which may be a sensor θ of the angular position of the turntable as shown in FIG. 3. Depending on the signal representing the angular position, the cluster of combiner means M1, M2, M3 determines the appropriate connection which should be made between a station-specific part and a common part available as it arrives at position θ1.

In an embodiment which will be described later, the connection may be made by a connector connected to the central shaft of the turntable using sliding contacts which connect in succession based on the periods determined by the angle θ2-θ1 for a treatment that comes around once per revolution of the turntable.

FIG. 2 shows a second example of a machine which keeps the same arrangement of eight stations P1 to P8, each comprising the actual workstation connected mechanically to the turntable 1, and a respective station-specific part Eq1 to Eq8, and in which three stations may be simultaneously within the angular sector θ1 to θ2.

In this second example, the machine comprises several common parts—in this case four common parts C1 to C4—which can each be linked as required to the station-specific part of two predetermined workstations, which workstations are separated by an angular distance equal to or greater than the angular distance between the angular position of entrance θ1 and the angular position of exit θ2 of the treatment applied in this angular sector.

Thus, common part C1 can be connected to station-specific part Eq1 or Eq5 when the corresponding stations P1, P5, which are diametrically opposite, move into the angular sector; common part C2 can be connected to station-specific part Eq4 or Eq8 when the corresponding stations P4, P8, which are diametrically opposite, move into the angular sector; common part C3 can be connected to station-specific part Eq3 or Eq7 when the corresponding stations P3, P7, which are diametrically opposite, move into the angular sector; and lastly, common part C4 can be connected to station-specific part Eq2 or Eq6 when the corresponding stations P2, P6, which are diametrically opposite, move into the angular sector.

By this means, a common part, C1 for example, operates twice with each revolution of the turntable:
first when the unit P1 with its station-specific part Eq1 enters the treatment sector comprised between θ1 and θ2, and
secondly when the diametrically opposite unit, in this case P5, in turn enters the treatment part comprised between θ1 and θ2.

The same applies to the other common parts, C2 to C4, which operate on the same principle.

In this second example of the invention, it will be seen that in the case of treatment units that can be connected electrically, the electrical connection is fixed and predetermined.

In FIG. 2, a cluster of combiner means M1, M2, M3, M4 connected to common parts C1, C2, C3, C4, respectively, enables a station-specific part Eq1 to Eq8 to be connected to one of the predetermined common parts C1, C2, C3, C4 as the corresponding unit enters position θ1 of the treatment zone.

As in the case of FIG. 1, to allow connection between a common treatment part and at least one predetermined station-specific part at the appropriate moment, the rotary treatment machine of the invention may have a sequence sensor, which may consist of a sensor θ of the angular position of the turntable as shown in FIG. 3.

Whenever the angular position sensor θ detects the arrival at position θ1 of a given station, for example station P1, an activation signal connects the station-specific part Eq1 of this station using means M1 of the cluster of combiner means M1, M2, M3, M4 to the predetermined common part C1, so that the operation can be carried out.

When common part C1 becomes available again, that is, when station P1 passes out of the angular sector θ1-θ2, this common part C1 can be connected by means M1, as shown in the third diagram of FIG. 3, to another station-specific part Eq5 (in the example shown in FIGS. 2 and 3).

In this case, in the course of one revolution of the turntable, unit C1 is connected either to station-specific part Eq1 or to station-specific part Eq5, or indeed to no station-specific unit during an inactive period.

One of the objects of the invention is of course to minimize this inactive period by allocating to a common part Ci another unit or a station-specific unit part, thus making it possible for example to connect up a third and sometimes even, depending on the amplitude θ2-θ1 of the treatment zone, a fourth workstation.

It will thus be seen that the number of components used to form one complete treatment unit can be reduced by sharing in a common part as many components as are necessary to carry out a treatment operation.

It will be observed that in the particular case of an eight-station machine in which only three stations are simultaneously present in the treatment zone, as shown in FIGS. 1 and 2, the configuration of FIG. 1 is that which allows the greatest possible reduction in the number of components, because it requires only three common parts as against four in the case of FIG. 2.

There are however cases in which the configuration of FIG. 2 is no less advantageous: thus, if four stations may be present simultaneously in a treatment zone, four common parts would have to be provided, and in this case neither of the configurations is better than the other. For each operation, a person skilled in the art will be capable of selecting the most appropriate arrangement.

FIG. 4 shows one particular embodiment of a treatment unit designed to carry out microwave treatment as described above.

The common part consists of a supply C1 connected by a multiplexer M1 to two magnetrons, one of which is the station-specific part Eq1 of a first workstation P1 and the other the station-specific part Eq2 of a second workstation P2.

Workstations P1 and P2 are separated by an angular distance greater than or equal to the angle θ2-θ1 of the work zone.

FIG. 5 shows another embodiment of the system of the invention applied to a resource for analyzing the signal detected on a workstation.

In this case, the common part is a signal analyzer C1 connected by a multiplexer M1 to two light sensors, one of which is the station-specific part Eq1 of a first workstation P1 and the other the station-specific part Eq2 of a second workstation P2.

Particularly in the case of cold plasma deposition, it can be important to know for each container being treated the condition of the plasma in order to be able to assess the quality of the deposition and, if necessary, monitor the treatment while the rotating machine is actually operating.

On the basis of the light intensity on the one hand, and if necessary on that of the spectral distribution of the light radiated by the plasma on the other, it is possible to use prerecorded tables obtained by sampling products which are assessed manually, to assess and so determine the quality of treated bottles and, if necessary, have a quality analyzer produce a signal associated with the workstation indicating whether the bottle is of the correct quality or of another quality.

Particularly in the case of poor quality, the bottle may then be tracked by a mechanism and ejected from the production process.

In other embodiments it is possible to sort the treated containers into quality categories by sending them in different directions at the exit 4 from the turntable as illustrated in FIGS. 1 and 2, along a number of transfer lines carrying treated containers sorted into classes of different qualities.

In such a system, the useful signal is transmitted from a peripheral workstation on the turntable to a central element called a signal adapter.

More specifically, the sensors constitute station-specific unit parts while the spectrometers and/or analyzers of lights light intensity for example, can be shared by several workstations, and so form common parts.

It will be realized that monitoring of light intensity or spectrography of the light emitted by the plasma is only useful while a container is still on its way through the treatment zone between angles θ1 and θ2.

Consequently the same system of the invention is also used for detection, and therefore, as defined above, monitoring of the treatment.

As shown in FIG. 5, the light sensors connected as station-specific unit parts to station P1 are located in the on-board module Eq1 and the station-specific part Eq2 is identical and is connected to a station P2 which may for example be mounted on a diametrically opposite workstation in one possible embodiment.

The signals coming from the sensors are then multiplexed by the multiplexer M1 and the multiplexed signal is passed to the input of a signal analyzer C1 as described above.

The signal analyzer C1 is thus a common unit or common part that is shared to the benefit of the station-specific parts Eq1 and Eq2 between two stations P1 and P2 of the turntable.

The sequencing of the multiplexer between its input connected to station-specific part Eq2 and station-specific part Eq1 is performed by means of the turntable state sensor.

Returning to the application of the invention to a microwave treatment system for producing a cold plasma in such a way as to deposit a barrier layer on the inside of a container contained in a workstation of a turntable of a rotating machine according to the invention, it was realized that it was possible to create a second level of resource sharing.

Specifically, it was realized that it was possible to run a treatment unit with three main parts:
a high voltage generator HT;
two microwave generators based on a chopper of the generated high voltage; and
microwave heads.

Thus, the station-specific parts comprise the actual microwave heads, which will be described later.

As to the common parts, these can be shared at two different levels, namely:
the high-voltage generator;
two microwave generators which constitute a second level of sharing; and
the microwave application heads A and B, one for each microwave generator.

The microwave generator is connected to heads belonging to the actual station by means of a multiplexer having one input leading to two outputs so that, depending on the angular position, the microwave energy is applied either to one or to the other of the application heads.

FIG. 7 shows the diagram of the sequencing applied by the multiplexer using five high-voltage generators in the case of a rotary treatment machine comprising twenty workstations angularly distributed around the turntable 1.

Each high-voltage generator is connected and supplies energy to two microwave generators.

Cables A and B depart from each generator in a fixed manner and each cable is connected to the microwave head of the workstation to which it corresponds.

As FIG. 7 shows, the last line of the table indicates the number of the station and its connections to the cable, to the microwave generator, and to the corresponding high-voltage generator.

It can therefore be seen that the resources have been shared on two levels.

FIG. 8 shows such an example for a high-voltage generator 80 that is connected in such a way as to provide the high-voltage energy to a microwave generator 82 and a microwave generator 84.

Each microwave generator 82 or 84 has cable terminations A and B connected to respective diametrically opposite stations on the turntable 1.

In this case, cable termination A of microwave generator 82 is connected to workstation P1 while cable termination B is connected to workstation P11.

In the same way, cable termination A of the second microwave generator 84 is connected to workstation P2, while cable termination B is connected to station P12.

FIG. 9 shows one particular embodiment of a sensor for activating the multiplexing means connected to a workstation.

A carriage is provided for a workstation which comprises a fixed part 90 in which a moving part 92 can move under the influence of a spring 94 so that it rolls permanently via a wheel 96 on a cam profile 98 which may be provided either on the peripheral edge of the turntable or on a cam mounted in relation with the central shaft of the rotating machine.

The moving part 92 is connected to a conductor 90A to which a first electric polarity is applied, while the bottom part of the support 90 is connected to a connector 90B.

When the rotation 3 occurs, the workstation carrying the carriage 90 arrives in the treatment zone θ1 and the cam profile then pushes the carriage 92 out so that a contact is established and the conductor 90B is raised to the electric potential of the conductor 90A, which activates the multiplexing.

Likewise the high profile 100 of the cam continues as far as position θ2 and a descent profile then moves down to the neutral position 102.

FIG. 10 shows another embodiment of a multiplexing means using the central shaft 110 of the rotating machine.

The central shaft 110 supports a ring 112 around which are arranged a plurality of conducting contacts 114, 116, 118 and 120.

Each workstation is provided with an arm or transfer element which will lead to the contact zone with the ring 112 and which carries contact brushes such as brush 122, in contact with the track 114, as the workstation moves through the treatment zone in such a way as to connect the station-specific unit to the common unit.

Electrical contacts 124 make it possible to indicate the angular position of the workstation. This activates the station-specific part of the treatment unit on the station in question.

FIG. 11 shows the station-specific part Eq1 of workstation P1 in the case of a microwave treatment.

Workstation P1 comprises a twin-walled enclosure 130 having a quartz wall inside which a vacuum can be created by a vacuum machine (not shown): it is into this that the container 132 in which a barrier layer is to be deposited is loaded.

An injector 134 is connected mechanically to a lid 136 that can be removed for the introduction of the bottle 132 into the enclosure 130.

When the lid 136 is placed in the treatment position, the receptacle 130 is completely evacuated. A gas is then injected through the injector 134.

The treatment unit also comprises its station-specific part Eq1 containing a magnetron 138 which is connected, by a tunnel or waveguide 140 constructed in a known manner, to the enclosure 130.

A microwave generator 142 is connected by a connector Cx to a cable 144 which is then attached to the common part of the treatment unit connected to the station-specific part Eq1 as described earlier.

As the station P1 moves through the treatment zone, the cable 144 allows high-frequency electrical energy produced by the common part of the treatment unit to be transmitted to the microwave generator 142 and to the magnetron 138.

The waveguide 140 then produces microwave radiation which, when correctly connected by the injector as is known, starts a cold plasma which, by the distribution of the electric field lines, then deposits the barrier layer on the inside wall of the bottle 132.

At the end of the treatment zone, the station-specific part Eq1 is deactivated and separated from the common part (not shown) of the treatment unit, the common part thereupon becoming available for sharing with the station-specific part of another station arriving at the entrance of the treatment zone.

1. A rotating machine for treating products, the rotating machine comprising a central turntable carrying a plurality of identical workstations (P1-P8), each performing during one revolution of the turntable an identical predetermined sequence of product treatment operations with a time lag from one station to the other, at least one of the operations of said sequence being carried out with a full lag from one station to the other,
characterized in that
each station (Pi) comprises at least one station-specific part (Eqi) with first means designed to be used when said operation with a full lag is being carried out,
and in that the machine comprises at least one common part (Cj) with second means designed to be used when said operation with a full lag is being carried out,
and in that the machine comprises combiner means (Mj) for linking said common part or parts (Cj) as required to the station-specific part (Eqi) of a workstation for the duration necessary to carry out said operation with a full lag on this station, and enable said operation to be carried out by the action of the first means of the station-specific part (Eqi) of this station and of the second means of the common part (Cj) connected thereto,
and in that combiner means (M1, M2, M3) are provided to allow a station-specific part (Eq1 to Eq8) to be connected to one of the common parts (C1, C2 or C3) available when the corresponding workstation enters the treatment zone.

2. The rotating machine for treating products, the rotating machine comprising a central turntable carrying a plurality of identical workstations (P1-P8), each performing during one revolution of the turntable an identical predetermined sequence of product treatment operations with a time lag from one station to the other, at least one of the operations of said sequence being carried out with a full lag from one station to the other,
characterized in that
each station (Pi) comprises at least one station-specific part (Eqi) with first means designed to be used when said operation with a full lag is being carried out,
and in that the machine comprises at least one common part (Cj) with second means designed to be used when said operation with a full lag is being carried out,
and in that the machine comprises combiner means (Mj) for linking said common part or parts (Cj) as required to the station-specific part (Eqi) of a workstation for the duration necessary to carry out said operation with a full lag on this station, and enable said operation to be carried out by the action of the first means of the station-specific part (Egi) of this station and of the second means of the common part (Cj) connected thereto,
and in that at least one combiner means (Mi) is permanently connected to the station-specific parts (Eq1, Eq5) of at least two workstations (P1, P5).

3. The rotating machine as claimed in claim 1, characterized in that the combiner means comprise a multiplexing means for activating the electrical connection between a common part and a station-specific part when said operation with a full lag is to be carried out in the station comprising said station-specific part.

4. The rotating machine as claimed in claim 3, characterized in that the combiner means (Mj) comprise an electrical connection assembly connecting a common part (Cj) to at least two station-specific parts (Eq1, Eq2) and a multiplexing means for activating the active electrical connection between the common part and a station-specific part when said operation with a full lag is to be carried out in the station comprising said station-specific part.

5. The rotating machine as claimed in claim 4, characterized in that the multiplexing means for activating the active electrical connection comprises an electronic multiplexing circuit that produces an activation signal when a station enters that portion of the revolution of the machine during which the operation is to be carried out.

6. The rotating machine as claimed in claim 5, characterized in that the multiplexing means for determining the active electrical connection comprises an electric multiplexing circuit consisting of at least one activation contactor controlled by the detection of the entrance into or exit from a portion (θ1-θ2) of a revolution of the rotating machine corresponding to the carrying out of said operation.

7. The rotating machine as claimed in claim 6, characterized in that the contactor is a commutator rotating about a central shaft of the rotating machine and sliding contacts making contact with the commutator.

8. The rotating machine as claimed in claim 7, characterized in that the contactor is set back from the station which it activates.

9. The rotating machine as claimed in claim 8, characterized in that the set-back contactor comprises a moving part designed to come into contact with a cam located so as to relate to that portion (θ1-θ2) of the revolution of the rotating machine which corresponds to the carrying out of said operation.

10. The rotating machine as claimed in claim 1, characterized in that the common part (C1) has a microwave supply generator for a magnetron for treating products in a treatment operation using a cold plasma and in that the station-specific part (Eq1, Eq2) comprises at least one magnetron.

11. The rotating machine as claimed in claim 10, characterized in that the microwave supply generator comprises a circuit for generating a high-voltage supply, designed to be shared between multiple station-specific parts.

12. The rotating machine as claimed in claim 11, characterized in that the microwave supply generator also comprises at least two microwave control circuits designed to be shared between multiple station-specific parts.

13. The rotating machine as claimed in claim 1, characterized in that the common part (C1) comprises means for measuring and analyzing a signal representing a treatment parameter and the station-specific part (Eq1, Eq2) comprises a signal sensor.

14. The rotating machine as claimed in claim 13, characterized in that the measurement and analysis means consist of an analyzer of the signal measuring the light intensity of the plasma generated by a magnetron and in that the signal sensor of the station-specific part (Eq1, Eq2) is a sensor of the energy radiated by the plasma generated by a magnetron provided for the station (P1, P2).

15. The rotating machine as claimed in claim 1, characterized in that the combiner means comprise a multiplexing means for activating the electrical connection between a common part and a station-specific part when said operation with a full lag is to be carried out in the station comprising said station-specific part.

16. The rotating machine as claimed in claim 1, characterized in that the common part (C1) has a microwave supply generator for a magnetron for treating products in a treatment operation using a cold plasma and in that the station-specific part (Eq1, Eq2) comprises at least one magnetron.

17. The rotating machine as claimed in claim 1, characterized in that the common part (C1) comprises means for measuring and analyzing a signal representing a treatment parameter and the station-specific part (Eq1, Eq2) comprises a signal sensor.
